(19) United States
(12) Patent Application Publication
(10) Pub. No.: US 2026/0287123 A1
(43) Pub. Date: Sep. 24, 2026

(54) DISPENSER FOR A PRESSURIZED FLUID, SUCH AS HYDROGEN, COMPRISING AN EMERGENCY SHUTOFF SYSTEM

(71) Applicant: L'Air Liquide, Societe Anonyme pour l'Etude et l’Exploitation des Procedes Georges Claude, Paris (FR)

(72) Inventors: Cyril DAVIN, Jouy-En-Josas (FR); Clement MOREAU, Jouy-En-Josas (FR)

(21) Appl. No.: 19/490,193

(22) PCT Filed: May 30, 2024
(86) PCT No.: PCT/EP2024/064889

§ 371 Date: Dec. 4, 2025

(30) Foreign Application Priority Data
Jun. 5, 2023 (FR) FR2305604

(51) Int. Cl. F17C 13/04

(52) U.S. Cl. CPC F17C 13/04; F17C 2205/0326; F17C 2205/0364; F17C 2270/0178

(57) ABSTRACT

A dispenser for a pressurized fluid, such as hydrogen, is provided, comprising a fluid source, a dispensing hose, and an emergency shutoff system. The system includes a whip-restraint cable connecting the dispensing hose to an anchor point, a shut-off valve for controlling fluid flow, and an actuator connected to the valve. The whip-restraint cable is configured to transmit force or movement applied to the dispensing hose directly to the actuator. When said force or movement reaches a predefined threshold, the actuator triggers the closing of the shut-off valve. The assembly may further utilize a support connecting the cable to the anchor point, wherein a portion of the support is movable through the anchor point to collaborate with the actuator, ensuring fluid containment in the event of hose tension or rupture.

### CROSS REFERENCE TO RELATED APPLICATIONS

This application is a § 371 of International PCT Application PCT/EP2024/064889, filed May 30, 2024, which claims the benefit of FR2305604, filed Jun. 5, 2023, both of which are herein incorporated by reference in their entireties.

### FIELD OF THE INVENTION

The invention relates to a dispenser for a pressurized fluid such as hydrogen, comprising an emergency shutoff system.

The dispenser may be a mobile unit, for example a gas-transporting truck or semitrailer, intended to replenish a fixed receiver such as a dispensing station or a mobile receiver such as a motor vehicle. Conversely, the dispenser may be a fixed unit (namely a fluid dispensing station) intended to resupply a plurality of receivers in succession or in parallel.

### BACKGROUND OF THE INVENTION

When fluid is being dispensed from the fluid dispenser to the fluid receiver, the dispensing hose may be inadvertently placed under tension. Such tensioning may occur for example when the fluid dispenser (in the case of a semitrailer) or the receiver (in the case of a vehicle that is to be replenished) makes a manoeuvre while the dispensing hose is held in position between the fluid dispenser and the fluid receiver.

The tension in the dispensing hose may damage it or cause it to rupture. If that happens, the fluid may escape from the dispensing hose thus damaged, without reaching the receiver. The fluid may thus spread out over the dispensing site.

Such a leak may generate a potentially dangerous explosive cloud, not to mention the fact that it constitutes a loss to the supplier and/or to the customer.

In order to limit the risks and losses that damage to, or rupture of, the dispensing hose may cause, and in order to make safe the area within which the dispensing of the fluid is performed, it is known practice to provide, in the dispenser, an emergency shut-off valve intended to control the flow of the fluid from the source to the dispensing hose. This valve can be closed in the known way by an operator in the event of rupture of the hose or following detection of a leak at the hose.

The solution described hereinabove is not entirely satisfactory because it remains dependent on there being an operator on the dispensing site and/or on the responsiveness of this operator.

Another solution for limiting losses caused by a rupturing of the dispensing hose consists in providing a pneumatic circuit arranged in parallel with the dispensing hose. The pneumatic circuit in this solution is intended to control the shut-off valve. Furthermore, the pneumatic circuit in this solution is connected to the dispensing hose by means of fasteners. Thus, if the dispensing hose should rupture, the pneumatic circuit is also ruptured, thus causing the flow of air in the pneumatic circuit to stop and causing the valve to close. This then results in the stopping of the flow of the fluid to the dispensing hose.

The solution described hereinabove therefore assumes that the flow of the fluid has to be controlled using a valve of pneumatic type. Such a constraint excludes the possibility of implementing this solution on a dispenser fitted with some other type of valve.

In addition, the solution described hereinabove requires the pneumatic circuit to rupture following rupture of the dispensing hose, so that this pneumatic circuit has to be replaced. The rupturing and then replacement of the pneumatic circuit runs counter to the current trend towards increasingly reusable solutions.

Finally, a third solution is to provide a tensioned cable inside the dispensing hose. The cable is equipped at its ends with plugs which are mounted with the ability to move inside end connectors that couple the dispensing hose to the dispensing source and to the fluid receiver.

In particular, the plugs are each mounted between two positions: an open position in which the plugs allow a stream of fluid to flow through the connectors of the hose and a closed position in which the plugs block said flow. If the dispensing hose should rupture or become damaged, a portion of the cable protrudes out of the hose in the ruptured or damaged region, pulling the plugs into their position in which they close off the stream.

The solution described hereinabove therefore requires a particular structure of dispensing hose, which remains costly to manufacture.

Consequently, a need has arisen to develop a fluid dispenser that at least partially overcomes the limits and disadvantages of the solutions described hereinabove.

### SUMMARY OF THE INVENTION

In an effort to overcome the deficiencies of the prior art discussed, supra, the invention, which is otherwise in accordance with the generic definition thereof given in the above preamble, is configured such that the web-restraint cable is configured to transmit to the actuator the force or movement applied to the dispensing hose, and in that the actuator is configured to bring about the closing of the shut-off valve when said force or said movement reaches a certain predefined threshold.

Thus, the invention makes use of the connection between the dispensing hose and the whip-restraint cable, and the possibility of force or movement transfer between these two elements, to introduce an actuator capable of collaborating with the whip-restraint cable and capable of registering the force or the movement transmitted to the whip-restraint cable by the dispensing hose to bring about closure of the shut-off valve when the force or the movement reaches a certain predefined threshold.

In any event, the dispenser comprises a fluid source, a dispensing hose fluidically connected to the fluid source, the dispensing hose being intended to be fluidically connected to a fluid receiver, a whip-restraint cable having a first end connected to the dispensing hose and a second end intended to be connected to an anchor point distinct from the dispensing hose, the whip-restraint cable being configured to be subjected to a force and/or to a movement of the same kind as that applied to the dispensing hose, a shut-off valve configured to control the flow of the fluid from the fluid source to the dispensing hose, and an actuator connected to the shut-off valve, the actuator being configured to bring about closing of the shut-off valve.

Moreover, by providing for the shut-off valve to be closed when the force or the movement registered by the actuator reaches a predefined threshold, the invention opens the way to an emergency shut-off system that prevents any flow of fluid to the damaged/ruptured dispensing hose, where the solutions of the prior art confined themselves to limiting the amount of fluid to escape from the damaged/ruptured hose.

Specifically, the predefined threshold for force or movement measured on the dispensing hose may be an indicator of forthcoming or imminent rupture of the dispensing hose.

Embodiments of the invention may comprise one or more of the following features:
the second end of the whip-restraint cable is mounted with the ability to move translationally with respect to the anchor point between a close-up position close to, and a distant position distant from, the anchor point,
the second end of the whip-restraint cable is configured to collaborate with the actuator,
the whip-restraint cable and the actuator are positioned one on each side of the anchor point,
the whip-restraint cable has a tensile breaking strength greater than that of the dispensing hose,
the dispenser comprises a support connecting the whip-restraint cable to the anchor point,
the support comprises a first part connected to the second end of the whip-restraint cable and a second part mounted with the ability to move through the anchor point,
the second part of the support is configured to collaborate with the actuator,
the first part of the support takes the form of a loop intended to engage in a mechanical connection with a loop formed at the second end of the whip-restraint cable,
the second part of the support comprises an end-of-travel stop configured to prevent the support and the whip-restraint cable from being pulled out of the anchor point,
the actuator and the support are positioned facing one another between a first relative position in which the actuator and the support are close together and a second relative position in which the actuator and the support are mutually distant,
the dispenser comprises a framework housing the fluid source, the framework comprises the anchor point to which the second end of the whip-restraint cable is connected,
the shut-off valve and the actuator are of pneumatic type,
the dispenser further comprises a pneumatic circuit connecting the shut-off valve and the actuator,
the actuator is of an electrical type, able to emit an electrical signal in response to a crossing of the predetermined threshold for force or movement registered by the actuator,
the dispenser comprises an electronic control unit configured to receive the electrical signal emitted by the actuator and to transmit said signal to the shut-off valve.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Further specific features and advantages will become apparent upon reading the description below, which is provided with reference to the following figures, in which:

FIG. 1 is a schematic view illustrating one example of a dispenser according to the invention, the dispenser comprising a dispensing hose, a whip-restraint cable, an actuator and an emergency shut-off valve.

FIG. 2 is a schematic view illustrating the dispenser of FIG. 1 following rupture of the dispensing hose.

FIG. 3 is a schematic view illustrating a simplified view of the dispenser of FIG. 1, the dispenser being connected to a fluid receiver.

FIG. 4 is a schematic view illustrating one embodiment of the actuator and of the emergency shut-off valve of the dispenser according to the invention, the actuator and the valve being in a first configuration.

FIG. 5 is a schematic view illustrating the actuator and the emergency shut-off valve of FIG. 4 in a second configuration.

### DETAILED DESCRIPTION OF THE INVENTION

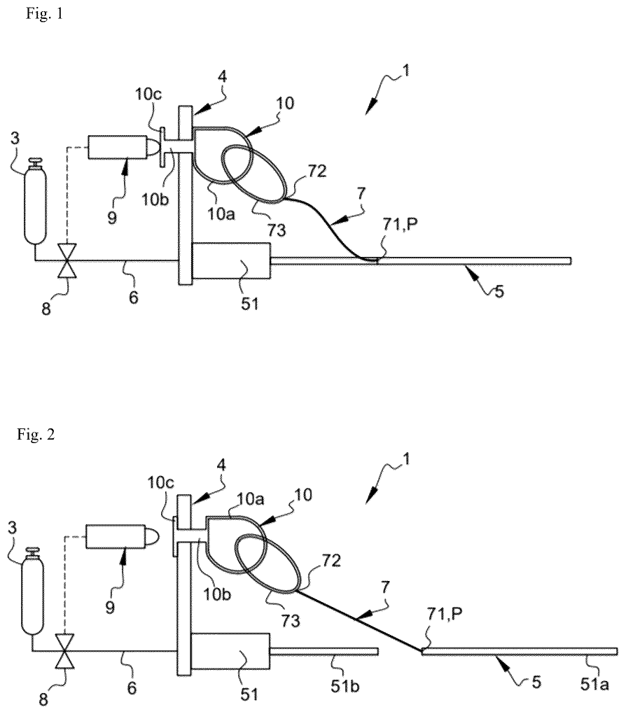

As illustrated in FIGS. 1 to 3, the invention relates to a dispenser 1 for a pressurized fluid such as hydrogen, intended to replenish a receiver 2.

The dispenser 1 according to the invention may be formed by a mobile unit (for example a pressurized gas-transporting truck or semitrailer). The receiver 2 that is to be replenished may be fixed (for example a dispensing station) or mobile (for example another gas-transporting truck or semitrailer or another type of motor vehicle).

Conversely, the dispenser 1 according to the invention may be a fixed unit (namely a fluid dispensing station) intended to replenish one or more mobile receivers. In the event of a plurality of fluid receivers, these may be replenished by the fluid dispenser 2 either in succession or in parallel.

The dispenser 1 and the receiver 2 each comprise one or more pressurized storage tanks. In what follows, the tank 3 of the dispenser will be referred to as “fluid source” or “source”, and the tank of the receiver 2 will be referred to as “tank that is to be filled” or “tank”.

As illustrated in FIG. 1, the fluid dispenser 1 comprises a fluid source 3 and a framework 4 forming a housing in which the fluid source 3 is positioned.

Furthermore, the dispenser 1 comprises a dispensing hose 5 which extends outside the framework 4. This hose 5 has an upstream end 51 connected to the framework 4 and a downstream end 52 intended to be connected to the receiver 2. The ends 51, 52 of the dispensing hose 5 are fitted with connectors for fluidic coupling with the framework 4 and with the receiver 2, respectively.

To ensure transfer of fluid from the fluid source 3 (which is positioned inside the framework 4) to the dispensing hose 5 (which extends outside the framework 4), the dispenser 1 comprises a transfer line 6 positioned inside the framework 4. In particular, this internal transfer line 6 is connected to the upstream end 51 of the dispensing hose 5.

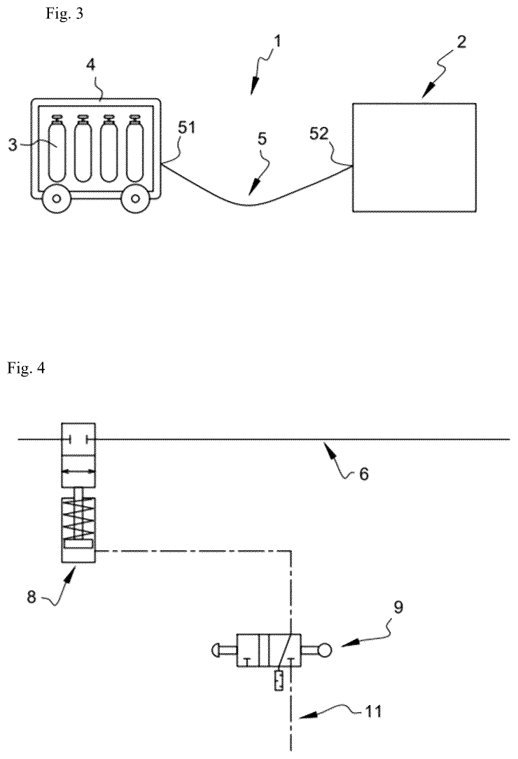

Moreover, in order to prevent a “whiplash” effect in the event of rupture of the dispensing hose 5, and with reference to FIG. 1 and FIG. 2, the dispenser 1 comprises a whip-restraint cable 7.

The whip-restraint cable 7 has a first end 71 connected fixedly (for example by a rigid connection) to the dispensing hose 5, and a second end 72 connected to an anchor point distinct from the dispensing hose 5. In particular, the first end 71 of the whip-restraint cable 7 is connected to the dispensing hose 5 at a connecting point P.

The connecting point P is positioned close to the upstream end 51 of the dispensing hose 5.

Advantageously, the anchor point is situated at the framework 4. In another embodiment, the anchor point may be provided outside of the framework 4, for example on a self-supporting structure situated in the vicinity of the dispenser 1.

It must be noted that the whip-restraint cable 7 has a tensile strength greater than that of the dispensing hose 5. Moreover, the dispensing hose 5 has a weak zone which, when the dispensing hose 5 and the whip-restraint cable 7 have been assembled with one another, is positioned between the upstream end 51 of the dispensing hose 5 and the connecting point P.

In order to control the flow of the fluid from the fluid source 3 to the dispensing hose 5, the dispenser 1 comprises a shut-off valve 8. The shut-off valve 8 is operated by an actuator 9.

Advantageously, the shut-off valve 8 is positioned along the transfer line 6 that connects the fluid source 3 to the dispensing hose 5. In other words, the shut-off valve 8 is positioned inside the framework 4.

Advantageously, the actuator 9 is also positioned inside the framework 4.

It should be noted that, because of the connection between the dispensing hose 5 and the whip-restraint cable 7, a force or a movement applied to one of them to a certain extent or with a certain amplitude (upwards of a threshold for example) may be transmitted to the other.

In particular, when the dispenser 1 (in the case of a gas-transporting truck or semitrailer) and/or the receiver 2 (in the case of a truck or other type of vehicle to be replenished) perform a manoeuvre while the dispensing hose 5 is in position between the dispenser 1 and the receiver 2, this manoeuvre may cause a tensile force to be applied to the dispensing hose 5. The force thus generated may in turn be transmitted to the whip-restraint cable 7 and in particular to the second end 72 of the whip-restraint cable 7.

Because of its tensile strength which is relatively low in comparison with the whip-restraint cable 7, the dispensing hose 5 may experience rupture when the force or the movement to which it is subjected exceeds a predefined threshold. Rupture occurs at the weak zone of the dispensing hose 5, which is then split into two portions: a downstream portion 51a attached to the receiver 2 and secured to the whip-restraint cable 7, and an upstream portion 51b attached to the framework 4.

According to the invention, the whip-restraint cable 7 is configured to transmit to the actuator 9 the force or movement applied to the dispensing hose 5, and the actuator 9 is configured to bring about the closing of the shut-off valve 8 when said force or said movement reaches a certain predefined threshold.

Thus, the invention makes use of the connection between the dispensing hose 5 and the whip-restraint cable 7, and the possibility of force or movement transfer between these two elements, to introduce collaboration between the whip-restraint cable 7 and the actuator 9 and give the actuator 9 the ability to register the force or the movement transmitted to the whip-restraint cable 6 by the dispensing hose 4. In that way, the actuator 9 may bring about closure of the valve 8 if a predefined threshold for force or movement is crossed.

Moreover, by providing for the shut-off valve 8 to be closed when the force or the movement registered by the actuator 9 crosses a predefined threshold, the invention opens the way to an emergency shut-off system capable of preventing any flow of fluid through a dispensing hose 5 that has become damaged or has ruptured.

Specifically, the crossing of a predefined threshold for force or movement measured on the dispensing hose 5 may be considered as being an indicator of forthcoming or imminent rupture of the dispensing hose 5.

With reference to FIG. 1 and FIG. 2, the second end 72 of the whip-restraint cable 7 is mounted with the ability to move with respect to the anchor point 4, namely with a certain degree of freedom. In particular, this second end 72 of the whip-restraint cable 7 is mounted between a close-up position close to the anchor point 4 (see FIG. 1) and a distant position distant from the anchor point 4 (see FIG. 2). The distant position of the second end 72 of the whip-restraint cable 7 with respect to the anchor point 4 corresponds to the whip-restraint cable 7 and the dispensing hose 5 being in a taut state.

Still with reference to FIG. 1 and FIG. 2, the second end 72 of the whip-restraint cable 7 is, advantageously, fixed to the anchor point 4 via a support 10.

The support 10 comprises a first part 10a, here in the form of a loop, and a second part 10b, here in the form of a rod.

In particular, the first part 10a of the support 10 collaborates with a loop 73 formed at the second end 72 of the whip-restraint cable 7. The two loops 10a, 73 are connected in the manner of two links of a chain.

The second part 10b of the support 10 is capable of translational movement with respect to the anchor point 4. Furthermore, the second part 10b of the support 10 is equipped with an end-stop 10c intended to prevent the support 10 (and therefore the whip-restraint cable 7) from being pulled out of the anchor point 4.

Finally, the second part 10b of the support 10 is positioned facing the actuator 9 between a first relative position in which the second part 10b of the support 10 and the actuator 9 are close together (see FIG. 1) and a second relative position in which the second part 10b of the support 10 and the actuator 9 are mutually distant (see FIG. 2).

In particular, in its distant position distant from the support 10, the actuator 9 brings about closing of the shut-off valve 8. In its close-up position close to the support 10, the actuator 9 keeps the shut-off valve 8 open or causes it to open and maintains or causes a flow of the fluid from the source 3 to the dispensing hose 5.

Definitively speaking, the support 10 performs a number of different functions. First of all, it provides the whip-restraint cable 7 with resistance to being pulled out of the framework 4. Next, it allows a movement of the whip-restraint cable 7 to be transmitted to the actuator 9. Finally, because it is positioned between the framework 4 and the whip-restraint cable 7, and because of its second part 10b which is able to move with respect to the framework 4, the support 10 limits the mechanical stresses to which the framework 4 could be exposed as a result of a tensile force applied to the whip-restraint cable 7.

It should be noted that when the anchor point 4 is formed by the framework 4, the first part 10a of the support 10 may be located outside the framework 4. The second part 10b of the support 10 may be located through a wall of the framework 4 to emerge inside the framework 4. The end-stop 10c is located inside the framework 4 where it collaborates with the actuator 9 and an internal wall of the framework 4.

When a force or a movement is applied to the dispensing hose 5, this force or movement is transmitted to the whip-restraint cable 7 and then to the mounting support 10, which therefore moves relative to the framework 4 and relative to the actuator 9. The actuator 9 detects or registers the movement of the support 10 then brings about closing of the shut-off valve 8 when the movement registered reaches a certain predefined threshold.

It should be noted that the actuator 9 may be of any type known to those skilled in the art, for example of electrical, mechanical, pneumatic, etc. type.

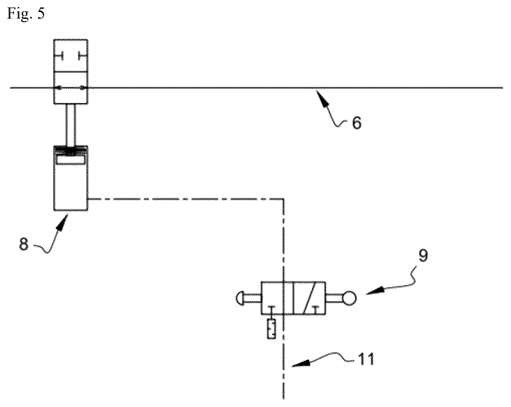

FIGS. 4 and 5 illustrate an actuator 9 of pneumatic type. The associated shut-off valve 8 is preferably also of pneumatic type. For this type of actuator 9 and this type of valve 8, the dispenser 1 comprises a pneumatic circuit 11 connecting the actuator 9 and the shut-off valve 8.

In a first configuration illustrated in FIG. 4, the pneumatic actuator 9 provides a flow of air through the pneumatic circuit 11, enabling the pneumatic valve 8 to be kept open and ensuring a flow of fluid from the fluid source 3 to the dispensing hose 5.

In a second configuration illustrated in FIG. 5, the pneumatic actuator 9 prevents air from flowing through the pneumatic circuit 11, causing the pneumatic valve 8 to close and shutting off the flow of fluid from the fluid source 3 to the dispensing hose 5.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise. “Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-10. (canceled)

11. A dispenser for a pressurized fluid comprising:
a fluid source;
a dispensing hose fluidically connected to the fluid source, the dispensing hose being configured to be fluidically coupled to a fluid receiver;
a whip-restraint cable having a first end connected to the dispensing hose and a second end configured to be connected to an anchor point distinct from the dispensing hose, the whip-restraint cable being configured to be subjected to a force and/or to a movement of a same kind as that applied to the dispensing hose;
a shut-off valve configured to control the flow of the fluid from the fluid source to the dispensing hose; and
an actuator connected to the shut-off valve, the actuator being configured to close the shut-off valve;
wherein the whip-restraint cable is connected to the actuator and configured to transmit to the actuator the force or movement applied to the dispensing hose, the actuator being configured to close the shut-off valve when said force or said movement reaches a certain predefined threshold,
wherein the dispenser further comprises a support connecting the whip-restraint cable to the anchor point, the support comprising a first part connected to the second end of the whip-restraint cable and a second part mounted with the ability to move through the anchor point, the second part of the support being configured to collaborate with the actuator.

12. The dispenser according to claim 11, wherein the second end of the whip-restraint cable is mounted with the ability to move translationally with respect to the anchor point between a close-up position close to, and a distant position distant from, the anchor point.

13. The dispenser according to claim 11, wherein the second end of the whip-restraint cable is configured to collaborate with the actuator, the whip-restraint cable and the actuator being positioned one on each side of the anchor point.

14. The dispenser according to claim 11, wherein the whip-restraint cable has a tensile breaking strength greater than that of the dispensing hose.

15. The dispenser according to claim 11, wherein the first part of the support takes the form of a loop intended to engage in a mechanical connection with a loop formed at the second end of the whip-restraint cable.

16. The dispenser according to claim 11, wherein the second part of the support comprises an end-of-travel stop configured to prevent the support and the whip-restraint cable from being pulled out of the anchor point.

17. The dispenser according to claim 11, wherein the actuator and the support are positioned facing one another between a first relative position in which the actuator and the support are close together and a second relative position in which the actuator and the support are mutually distant.

18. The dispenser according to claim 11, further comprising a framework housing the fluid source, the framework comprising the anchor point to which the second end of the whip-restraint cable is connected.

19. The dispenser according to claim 11, wherein the shut-off valve and the actuator are of pneumatic type, and in that the dispenser further comprises a pneumatic circuit connecting the shut-off valve and the actuator.

20. The dispenser according to claim 11, wherein the actuator is of an electrical type, configured to emit an electrical signal in response to a crossing of the predetermined threshold for force or movement registered by the actuator, the dispenser comprising an electronic control unit configured to receive the electrical signal emitted by the actuator and to transmit said signal to the shut-off valve.
